(19) United States
(12) Patent Application Publication
(10) Pub. No.: US 2017/0298963 A1
(43) Pub. Date: Oct. 19, 2017

(54) Integral Hydraulic System

(71) Applicant: Big Lift, LLC, Lombard, IL (US)

(72) Inventors: Xu Linjie, Hangzhou (CN); Liu Shunli, Hangzhou (CN); Lin Zuqian, Hangzhou (CN)

(21) Appl. No.: 15/163,315

(22) Filed: May 24, 2016

(30) Foreign Application Priority Data
Apr. 15, 2016 (CN) 201610239511.8

(51) Int. Cl. F15B 15/14; F15B 15/08

(52) U.S. Cl. CPC F15B 15/149; F15B 15/088

(57) ABSTRACT

The disclosure provides an integral hydraulic system, which includes a valve board, a lift cylinder and a reservoir connected into one integral valve body, wherein the integral valve body is further connected to an electric motor and a hydraulic gear pump, so as to form a complete power unit that includes all the valves utilized in the different functions that control a hydraulic fluid circuit in lifting and lowering of a plunger rod of the lift cylinder.

### CROSS-REFERENCE TO RELATED APPLICATION

This application claims priority to Chinese Patent Application No. 201610239511.8, filed Apr. 19, 2016, which is hereby incorporated by reference in its entirety.

### TECHNICAL FIELD

The invention relates to lifting mechanisms for use in lifting equipment, such as a pallet truck, and in particular to an integral hydraulic system that combines a hydraulic power unit, hydraulic control unit and hydraulic action unit into one complete unit.

### BACKGROUND

Hydraulic systems for lifting equipment, such as pallet trucks, usually include a power unit, a control unit and an action unit. These components are an important part of a pallet truck, and the hydraulic system's function and cost are directly related to the cost, market prospects and promotion of the entire pallet truck. This is especially true as more modern pallet trucks have become lighter and less expensive, making the cost and volume or space occupied by the hydraulic system very important.

At present, pallet truck lifting systems generally are of two kinds: manual and electrical. Manual hydraulic systems include a pump that is easier and cheaper to make, but requires pumping by an operator, and therefore, more labor during use of the system. Manual hydraulic systems also have limited lifting capacity, which together with the pumping required, affects the efficiency of using the pallet truck. On the other hand, the hydraulic systems in electric pallet trucks tend to have components that are located separately from each other, such as an electric motor as a power unit, a valve body that serves as a hydraulic control unit, and a lift cylinder that serves as a hydraulic action unit, with a reservoir, a pump, the valve body and the lift cylinder fluidly connected to each other by a variety of conduits and/or houses. The extra components add cost and require more volume for the operable system. They also present more potential for leakage of hydraulic fluid and increased maintenance, all of which may make electrical hydraulic systems less popular. As a result, it would be desirable to have a hydraulic system that can replace the manual manpower needed with electric power, but without greatly increasing the cost and volume of the system.

### SUMMARY

The subject matter of this disclosure provides advantages over the structures of typical prior art hydraulic systems used in lifting equipment, such as pallet trucks. In contrast to prior art manual or electrical hydraulic systems, the present disclosure provides an example integral hydraulic system having a valve board, a lift cylinder and a reservoir to provide an integral valve body, which advantageously can be directly connected to an electric motor and a hydraulic gear pump, so as to achieve a single unit.

This improved configuration permits a reduction in cost, volume and potential fluid leakage for pallet trucks. Indeed, this configuration is able to provide a pallet truck having a compact, integral hydraulic system that has significant lifting capacity, enhanced reliability and improves operator efficiency.

In a first aspect, the disclosure provides an integral hydraulic system, including a valve board, a lift cylinder and a reservoir connected into one integral valve body, wherein the integral valve body is further connected to an electric motor and a hydraulic gear pump, so as to form a complete power unit that includes valves utilized in the different functions that control a hydraulic fluid circuit in the lifting and lowering of a plunger rod of the lift cylinder.

In another aspect, the disclosure provides an integral hydraulic system that has a lowering valve that includes an unloading spring, an O-ring, a firing pin, and a firing pin pedestal that are installed inside the valve board.

In a further aspect, the disclosure provides an integral hydraulic system that has a lifting valve that includes a valve orifice, a screw, a valve needle, a valve spring, and a ball that provide a one-way valve biased by the valve spring.

In another aspect, the disclosure provides an integral hydraulic system that has a relief valve that includes a screw, an adjusting screw, a spring, a ball pedestal, and a ball that are installed inside the valve board.

Thus, the present disclosure presents alternatives to prior art manual and electric hydraulic systems for lifting equipment, such as pallet trucks and provides advantageous features by bringing together previously separated components to greatly improve the convenience, utility and efficiency in operating such lifting equipment. It is to be understood that both the foregoing general description and the following detailed description are exemplary and provided for purposes of explanation only, and are not restrictive with respect to the claimed subject matter. Further features and advantages will become more fully apparent in the following description of the example preferred embodiments and from the appended claims.

### BRIEF DESCRIPTION OF THE DRAWINGS

In describing the preferred examples, references are made to the accompanying drawing figures wherein like parts have like reference numerals. For ease of viewing and comprehension, several of the figures show less than an entire hydraulic system or show only particular components of the system.

FIG. 1 is a front left perspective exploded view of an integral hydraulic system.

FIG. 2 is a front right perspective exploded view of the integral hydraulic system shown in FIG. 1.

FIG. 3 is a schematic cross sectional view of the valve body of the integral hydraulic system shown in FIG. 1.

It should be understood that the drawings are not necessarily to scale. While some mechanical details of hydraulic lifting systems for lifting equipment, including some details of fastening or connecting means and other plan and section views of the particular components have been omitted, such details are considered to be within the comprehension of those skilled in the art in light of the present disclosure. It also should be understood that the present disclosure is not limited to the examples illustrated and described.

### DETAILED DESCRIPTION OF THE PREFERRED EMBODIMENT

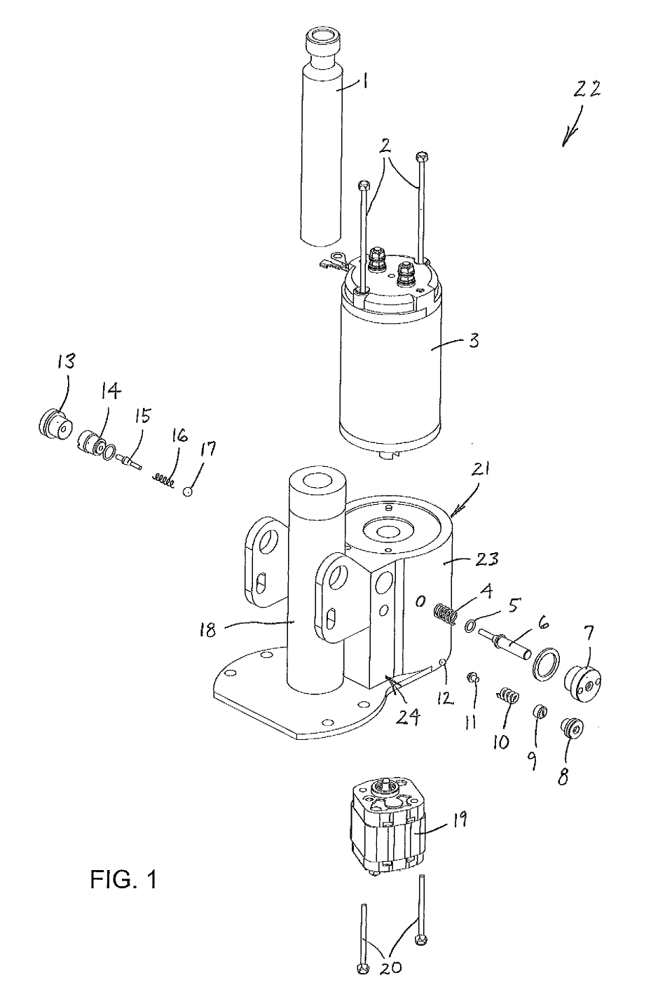

This disclosure provides solutions to the technical problem presented by existing manually and electrically operated hydraulic lifting systems, such as are used in pallet trucks. The disclosure teaches an integral hydraulic system having a valve board, a lift cylinder and a reservoir combined within an integral valve body, which advantageously is further directly connected to an electric motor and a hydraulic gear pump, so as to achieve a self-contained, full power unit. In fact, an example of such an integral hydraulic system is disclosed herein, such as may be used in pallet trucks, or other lifting equipment. The system is described further herein in reference to a preferred embodiment shown in the accompanying drawing FIGS. 1-3. It will be appreciated, however, that the invention may be constructed and configured in various ways and is not limited to the specific example in the form of the preferred embodiment shown and described herein.

To overcome the disadvantages of present manual and electric pumps used in lifting equipment, the present disclosure provides an integral hydraulic system that combines the space saving advantages of a manual pump system and the lower labor, higher lifting capacity of an electric pump system. But to do so, the example integral hydraulic system utilizes an entirely new way to connect the components, which also reduces the potential for leakage, while reduces the number of components. The integral hydraulic system includes an electric motor, a hydraulic gear pump and a power source, together with an integral valve body that includes a valve board, a lift cylinder and a reservoir, with all of the components connected together within a relatively small volume.

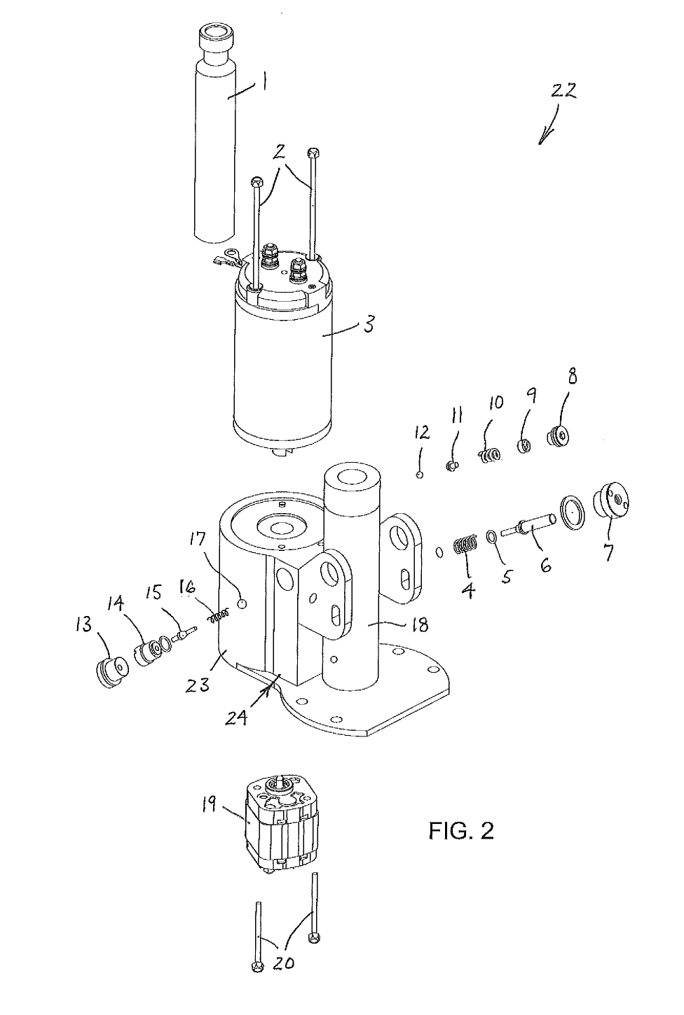

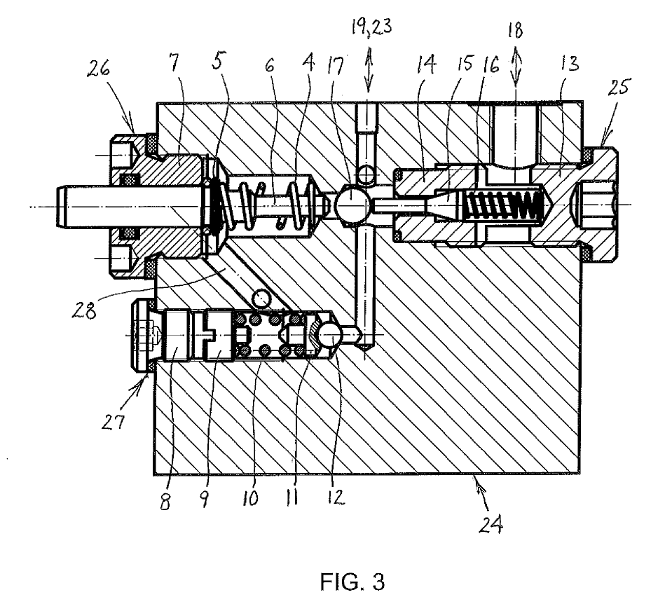

In FIGS. 1 and 2, a motor 3 and a hydraulic gear pump 19 are connected to a valve body 21 by screws 2, 20, respectively, making up a single, but complete power unit of an integral hydraulic system 22. The valve body 21 includes a reservoir 23, a valve board 24 and lift cylinder 18, the combination of which reduces the volume of the entire system, while internalizing the fluid connections to avoid leakage and pollution. A cross section of the valve board 24 is shown in FIG. 3.

When an operator elects a lifting function, hydraulic fluid flows from the hydraulic gear pump 19 of the integral hydraulic system 22, to a lifting valve 25 that is constructed within the valve board 24 and includes a valve end 13, a valve seat screw 14, a valve needle 15, a first spring 16, and a first ball 17, such as a steel ball, all of which are combined essentially into a one-way valve biased by the first spring 16 toward a closed position, shown in FIG. 3. The flow of hydraulic fluid from the hydraulic gear pump 19 overcomes the force of the first spring 16 and moves the first valve needle 15 to an open position, to permit the hydraulic fluid to enter into the lift cylinder 18, so as to push upward the plunger rod 1 of the lift cylinder 18, realizing the desired lifting function. At this moment, the fluid pressure in the lift cylinder 18 below the plunger rod 1 makes the first ball 17 seal the opposed passage within the valve board 24 that is associated with a lowering valve 26, and the first spring 16 and increased hydraulic pressure now in the cylinder 18 pushes the valve needle 15 to engage the valve seat screw 14, so as to lock and retain the lifting pressure within the valve board 24 of the valve body 21.

The lowering valve 26 includes an unloading second spring 4, an O-ring 5, a firing pin 6, and firing pin pedestal 7, all combined to have the firing pin 6 biased by the second spring 4 toward a withdrawn position, shown in FIG. 3. When the plunger 1 is in a raised position and an operator selectively chooses to operate the lowering valve 26, the firing pin pedestal 7 and firing pin 6 are utilized to push the first ball 17 back toward the lifting valve 25, so as to push the valve needle 15 to an open position, permitting the reversal of fluid flow to the reservoir 23 and pump 19 as the plunger rod 1 descends within the lift cylinder 18. After lowering the plunger rod 1, the unloading second spring 4 will force the firing pin 6 to reset with the firing pin pedestal 7 by moving toward the withdrawn position.

If the system pressure exceeds a selected rated maximum pressure, a relief valve 27 will protect the system by relieving the excess pressure. In particular, the hydraulic fluid will force the second ball 12, such as a steel ball, and a ball pedestal 11 to an open position by overcoming the force of a third spring 10, so as to open the relief valve 27 to a passage 28 that provides pressure relief. The maximum rated pressure for the system can be adjusted by an adjusting screw 9, which controls the biasing pressure applied by the third spring 10, and a sealing screw 8 is used to seal the relief valve 27.

In light of the above description, it will be appreciated that a valve board 24, a lift cylinder 18 and a reservoir 23 make up one integral valve body 21. In addition, an electric motor 3 and a hydraulic gear pump 19 are connected to the valve body 21, such as by the two screws 2, 20, respectively, or other suitable fasteners. Together these components constitute a power unit of an integral hydraulic system 22. Advantageously, the valves 25, 26, 27 within the valve board 24 of the integral hydraulic system 22 provide hydraulic fluid flow for the all of the different required functions. For instance, these valves included the lifting valve 25, which is biased to be a one-way valve used when raising the plunger rod 1 of the lift cylinder 18 for lifting, a manual lowering valve 26 for reversing the fluid flow for lowering the plunger rod 1, and a relief valve 27 that protects the entire system from damage that may be caused by excessive pressures. The lift cylinder 18 of the valve body 21 uses the plunger rod 1 to realize the lifting and lowering. As described above, hydraulic fluid enters the lift cylinder 18 via the lifting one-way valve 25, and pushes the plunger rod 1 to provide lifting. The lowering valve 26 utilizes the firing pin 6 to push to an open position the valve needle 15 of the lifting valve 25, permitting return of the hydraulic fluid and lowering of the plunger rod 1. The firing pin 6 and valve needle 15 will be reset by the second spring 4 and first spring 16, respectively. The relief valve 27 will protect the entire integral hydraulic system 22 when the lift cylinder 18 is subjected to excess weight applied to the plunger rod 1, and the pressure at which the relief valve is activated can be adjusted by use of the adjusting screw 9 that controls the length of the space the third spring 10 occupies behind the ball pedestal 11, which pushes the second ball 12.

In the preferred example integral hydraulic system 22, the valve board 24, lift cylinder 18 and reservoir 23 make up one integral valve body 21 that is connected directly to the electric motor 3 and hydraulic gear pump 19, such that no extra externally extending conduits or tubes are used in the fluid connections of the components. As a result of the connections within the valve body 24 shown in FIG. 3, the power unit of the integral hydraulic system 22 is of significantly smaller volume, complexity and weight, providing for a more compact and reliable hydraulic system.

The valve body 24 uses the valve needle 15 to realize the sealing of the fluid passages, and the first spring 16 provides a biasing force. These components are included in the one-way lifting valve assembly 25 with simple and reliable operation, when an operator decides to energize the hydraulic gear pump 19 to send pressurized fluid to the valve body 24 to affect lifting, which overcomes the biasing force of the first spring 16.

Thus, during lifting, the hydraulic fluid will be drawn from the reservoir 23 and pumped by the hydraulic gear pump 19 to the one-way lifting valve 25, and will overcome the biasing force of valve spring 16, move the valve needle 15 to an open position and enter the lift cylinder 18. The hydraulic fluid then will push the plunger rod 1 upward to realize the desired lifting. When lowering the plunger rod 1, the firing pin 6 will push the first ball 17, so as to push the valve needle 15 to an open position and permit return fluid flow toward the hydraulic gear pump 19 and reservoir 23. In the preferred example, the third spring 10 forces the ball pedestal 11, which pushes the second ball 12 to a closed position. The adjusting screw 9 may be used to adjust the maximum rated pressure permitted before the relief valve 27 will be triggered within the valve board 24 of the integral hydraulic system 22.

When an operator wishes to lower the plunger rod 1, the operator will actuate a knob on a device, such as on a pallet truck operating handle, so as to move an activation plate that pushes the firing pin 6, so as to cause the firing pin 6 to push the first ball 17 to an open position, which in turn pushes the valve needle 15 to realize the reversing of the flow of hydraulic fluid. The firing pin 6 and its firing pin pedestal 7 are sealed by the O-ring 5 and biased by the unloading second spring 4, to be able to reset and be ready for another operation.

By using the above described design, one realizes advantages over a manual pump, which has low efficiency and requires much operator effort. Adding the connection to the electric motor 3 and hydraulic gear pump 19 results in the integral hydraulic system 22 that serves as the power unit. This is being done in a way that retains the small volume and at a low cost, effectively providing an electric hydraulic transmission that reduces the intensity of the work required by the operator. By integrating the lift cylinder 18 and valve board 24, the system volume is reduced and the lack of tubes and connectors avoids potential leakage and pollution, making the entire integral hydraulic system 22 more safe and reliable.

Based on the above described apparatus and methods, the disclosure presents highly advantageous solutions for problems encountered with typical hydraulic systems used in lifting equipment, such as pallet trucks. The integral hydraulic system utilizes a valve board, a lift cylinder and a reservoir to provide an integral valve body, which advantageously can be connected directly to an electric motor and a hydraulic gear pump to achieve the full power unit. This space-efficient assembly increases lifting capacity over that of a typical manual hydraulic system, while reducing operator effort. The integral hydraulic system also reduces potential leakage and environmental impact, while improving operator efficiency.

It will be appreciated that the present disclosure shows and demonstrates a preferred example integral hydraulic system, which is discussed in the context of a pallet truck lifting system. Indeed, this example is merely illustrative and is not to be considered limiting. It will be apparent to those of ordinary skill in the art that various hydraulic lifting systems may be constructed and configured for use in lifting equipment, without departing from the scope or spirit of the present disclosure. Thus, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. An integral hydraulic system, comprising a valve board, a lift cylinder and a reservoir connected into one integral valve body, wherein the integral valve body is further connected to an electric motor and a hydraulic gear pump, so as to form a complete power unit that includes valves utilized in the different functions that control a hydraulic fluid circuit in the lifting and lowering of a plunger rod of the lift cylinder.

2. The integral hydraulic system of claim 1, wherein the integral valve body is connected by two screws to the electric motor and by two further screws to the hydraulic gear pump.

3. The integral hydraulic system of claim 1, wherein a lowering valve includes an unloading spring, an O-ring, a firing pin, and a firing pin pedestal that are installed inside the valve board.

4. The integral hydraulic system of claim 1, wherein a lifting valve includes a valve orifice, a screw, a valve needle, a valve spring, and a ball that provide a one-way valve biased by the valve spring.

5. The integral hydraulic system of claim 1, wherein a relief valve includes a screw, an adjusting screw, a spring, a ball pedestal, and a ball are installed inside the valve board.
